(19) United States
(12) Patent Application Publication
(10) Pub. No.: US 2014/0212653 A1
(43) Pub. Date: Jul. 31, 2014

(54) Low Density Structural Laminate

(71) Applicant: Emil RADOSLAV, Dundas (CA)

(72) Inventors: Michael SLYWCHUK, Stoney Creek (CA); Diane STOGIANNES, Stoney Creek (CA)

(73) Assignee: Emil RADOSLAV, Dundas (CA)

(21) Appl. No.: 14/229,373

(22) Filed: Mar. 28, 2014

Related U.S. Application Data
(63) Continuation of application No. 11/907,746, filed on Oct. 17, 2007, now abandoned.
(60) Provisional application No. 60/852,003, filed on Oct. 17, 2006.

(51) Int. Cl. B32B 15/04; B32B 27/20; B32B 15/088; B32B 15/085; B32B 37/02; B32B 37/24

(52) U.S. Cl. CPC B32B 15/046; B32B 37/02; B32B 37/24; B32B 15/088; B32B 15/085; B32B 27/20
USPC 428/317.9; 156/313; 156/244.11; 428/457; 428/458; 428/461; 428/464; 428/337

(57) ABSTRACT

The present invention provides a structural laminate comprising a core layer disposed between and bonded to each of a first metal skin layer and a second metal skin layer, the core layer comprising: a low density composite layer including a mixture of thermoplastic resin, and natural fiber. The core layer may further include a first and a second adhesive layer interposed between each of the first and the second metal skin layers and the composite layer.

### CROSS-REFERENCE TO RELATED APPLICATION

This present application is a continuation of U.S. patent application Ser. No. 11/907,746 filed Oct. 17, 2007, which claims the benefit under 35 U.S.C. §119(e) of provisional patent application Ser. No. 60/852,003, filed Oct. 17, 2006, the contents of which are hereby incorporated by reference.

### FIELD OF THE INVENTION

The present invention relates to a structural laminate and more particularly to a low density structural laminate. The present invention further relates to a method for producing a low density structural laminate.

### BACKGROUND OF THE INVENTION

Sheet steel is used extensively to form panels. The required structural characteristics, such as stiffness, vary depending upon the specific application. When higher stiffness values are required, the steel thickness is typically increased. Increasing sheet steel thickness, however, produces a panel that is not only heavier, but also more expensive.

A number of approaches have been taken in the past to provide improved structural characteristics of panels, without substantially increasing weight or material cost. For example, composites of steel sheets having a solid polymer core have been used in applications where sound deadening and vibration dampers are required. The specific stiffness of polymer core products, however, is less than desirable.

U.S. Pat. No. 5,985,457 [Clifford (Clifford #1)] teaches a structural panel which comprises a metal and paper composite. The paper core is a web which is adhesively bonded to the metal skins and which may have openings to create paths for adhesive bridges between the metal skins to minimize failure caused by buckling.

U.S. Pat. No. 6,171,705 [Clifford (Clifford #2)] teaches a structural laminate having first and second skins of sheet metal. A fibrous core layer such as kraft paper and plastic fiber paper is provided between the sheet metal skins and is bonded to the skins. In one aspect, the paper core layer is impregnated with an adhesive resin which bonds the core layer directly to the skins. Additionally, the core layer is bonded together with heat and pressure to form a single layer. In another aspect, layers of adhesive are placed between the core material and the metal skins that bond the core to the skins.

While the paper core and fibrous core laminates of Clifford #1 and Clifford #2 represent a significant improvement in the art, there remains room for improvement.

There is a continual need to produce a panel having the required structural properties discussed above and also having a lower density and a lower cost compared with traditional panels. Accordingly, there is a need for a structural laminate which obviates or mitigates at least some of the above-presented disadvantages.

### SUMMARY OF THE INVENTION

In one aspect, the present invention provides a structural laminate comprising a core layer disposed between and bonded to each of a first metal skin layer and a second metal skin layer, the core layer comprising a low density composite layer.

In an alternative embodiment the present invention provides a structural laminate comprising a composite layer disposed between and bonded to each of a first metal skin layer and a second metal skin layer, the composite layer comprising a mixture of thermoplastic resin and natural fiber. In one aspect, the low density composite layer is a low density natural fiber-plastic composite. In one aspect, the composite layer comprises at least some recycled materials selected from the group comprising recycled natural fibers and recycled synthetic materials.

In a further embodiment the present invention provides a structural laminate comprising a composite layer disposed between and bonded to each of a first metal skin layer and a second metal skin layer, the composite layer comprising a mixture of thermoplastic resin, natural fiber and at least one foaming agent. In one aspect, the composite layer comprises at least some recycled materials selected from the group comprising recycled natural fibers and recycled synthetic materials.

In another aspect, the present invention provides a process for producing a low density structural laminate comprising the steps of: forming a low-density composite layer comprising thermoplastic resin and natural fiber; placing an adhesive layer on each surface of the composite layer; disposing the composite layer between a first metal skin layer and a second metal skin layer to define an interim laminate; and pressing the interim laminate at a first pressure to produce the structural laminate.

In an alternate embodiment, the present invention provides a process as described above with the additional step of surface treating the composite layer prior to application of the adhesive layer.

### BRIEF DESCRIPTION OF THE DRAWINGS

The present invention will be described in further detail with reference to the accompanying drawings in which:

FIG. 1 illustrates a sectional side view of one embodiment of the low density panel of the present invention; and

FIG. 2 illustrates a block diagram of one embodiment of the process for forming the low-density structural laminate.

### DETAILED DESCRIPTION OF THE PREFERRED EMBODIMENTS

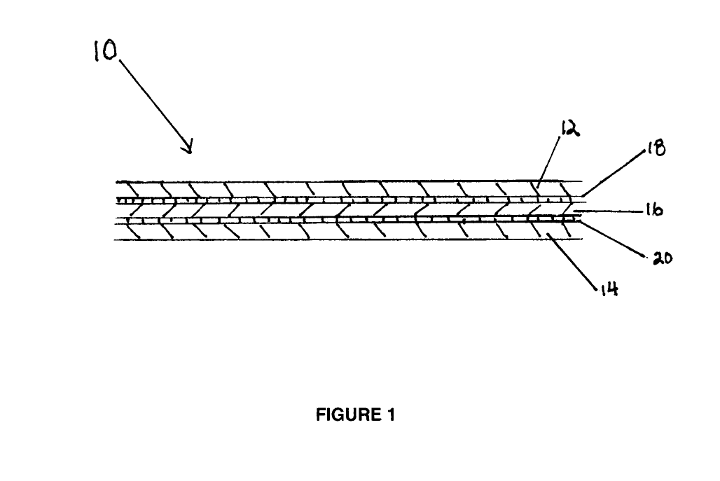

The present invention provides a low density structural laminate, indicated generally at numeral 10 in FIG. 1.

The low density panel 10 includes a first metal skin layer 12 and a second metal skin layer 14. Interposed between the first and second metal skin layer 12, 14 is a low density composite layer 16.

Disposed between the first metal skin layer 12 and the low density composite layer 16 is a first adhesive layer 18. A second adhesive layer 20 is disposed between the second metal skin layer 14 and the low density composite layer 16. As will be described in an alternate embodiment, the first adhesive layer 18 and the second adhesive layer 20 are optional such that the low density composite layer 16 is bound to the first and second metal skin layer 12, 14 without the use of one or more adhesive layers.

Referring again to FIG. 1, the first adhesive layer 18 serves to bond the low density composite layer 16 to the first metal skin 12. Likewise, the second adhesive layer 20 serves to bond the second metal skin 14 to the low density composite layer 16.

The first and second adhesive layers 18, 20 may be the same or different, although preferably the same. Suitable adhesives that may be used include adhesives that are compatible with the composite layer and the metal skins to which the adhesive will be applied. Suitable quantities of adhesive will depend on the properties of the adhesive used, and the choice of adhesive quantity will be within the purview of persons skilled in the art. Examples of adhesives that may be used include, but are not limited to, thermoplastic adhesives, thermoset adhesives or combination adhesives such as reactive hot melt polyurethane (PUR). The adhesive may be applied to the metal skin layer or the composite layer. Examples of suitable adhesives that may be used include, but are not limited to Rohm and Haas 1223 PE resin or 5003 PUR resin. When this resin is used, first adhesive layer 18 and second adhesive layer 20 can suitably each be applied in a layer between about 0.0005 inches and about 0.010 inches in thickness and more preferably between about 0.001 inches and 0.005 inches in thickness. Other suitable adhesives may also be envisaged which are adapted to bind material without heating the adhesive.

The particular choice of metal for metal skin layers 12 and 14 used in structural laminate 10 is not particularly restricted. First metal skin layer 12 and second metal skin layer 14 may be the same or different. Non-limiting examples of suitable metal skin layers for use in the present invention include aluminum, cold rolled steel, galvanized steel, tin-coated steel, zinc coated steel, low carbon micro-alloyed high-strength steel and stainless steel. In a preferred embodiment of the present structural laminate, one or both of first metal skin layer 12 and second metal skin layer 14 comprise steel. The metal skin layers 12 and 14 described herein, refer to recycled/virgin metal and any combinations thereof. In a particularly preferred embodiment of the present structural laminate, one or both of first metal skin layer 12 and second metal skin layer 14 comprise pre-painted zinc-coated steel.

Preferably, first metal skin layer 12 and second metal skin layer 14 have the same or different thicknesses and the thickness of each is at least 0.005 inches. More preferably, first metal skin layer 12 and second metal skin layer 14 have the same or different thicknesses and the thickness of each is in the range of from about 0.005 inches to about 0.030 inches. Most preferably, first metal skin layer 12 and second metal skin layer 14 have the same or different thicknesses and the thickness of each is about 0.019 inches.

According to one embodiment, the low density composite layer 16 is a low density natural-fiber plastic composite. According to another embodiment, the low density composite layer 16 is made from a material including a mixture of thermoplastic resin and natural fiber. The natural fibers referred to herein may be recycled and/or virgin natural fibers or a combination thereof. Preferably the low density layer is formed from uniformly distributed thermoplastic resin and natural fiber that are mixed together (e.g. extruded together) to form a thin flat board of uniform thickness.

In one embodiment, the composite layer comprises at least some recycled materials selected from the group comprising recycled natural fibers and recycled synthetic materials. For example, the composite layer comprises virgin and/or recycled natural fibers and/or thermoplastic resin and/or recycled synthetic materials. Examples of natural fibers (recycled/virgin) are provided below. Examples of recycled synthetic materials include, for example, carpet waste, recycled resin, polypropylene and/or polyethylene waste and any other combinations of synthetic materials. Thus, the composite layer may be formed entirely of recycled materials or a portion thereof formed of recycled materials.

Preferably a foaming agent is incorporated into the composite layer which will enable a composite layer to be produced that has a reduced weight. An example of a suitable foaming agent that may be used includes the commercially available product Expancel®, manufactured by Akzo Nobel. Other foaming agents known to a person skilled in the art may also be used. The foaming agent may be incorporated in the range of between about 1% and about 5% and preferably in the range of about 2% and about 3%. The foaming agent which is introduced into the composite layer during the manufacturing of the composite layer is used to reduce the density of the composite layer. For example, the foaming agent creates small voids or gaps (e.g. air pockets) between the solid materials of the composite layer. That is, gaps are created within the natural fiber (recycled/virgin) and the thermoplastic resin. By increasing the amount of foaming agent, the density of the composite layer is decreased and a resulting lighterweight composite layer is formed.

The thermoplastic resin that is used in the low density core may be selected from any thermoplastic resin material. The thermoplastic resin may also be a mix of more than one type of thermoplastic resin. Preferably the thermoplastic resin is polypropylene or polyethylene. The thermoplastic resin referred to herein includes recycled and/or virgin thermoplastic resin. For example, the thermoplastic resin includes, but is not limited to recycled and/or virgin polypropylene, polyethylene, or nylon.

The natural fiber that is used in the low density composite layer may be any natural fiber. Examples of the type of natural fiber that may be used include plant fiber, wood fiber, for example oak flour, and rice husks. Preferably the natural fiber is rice husks. Other types of natural fibers that may be used include, for example, flax, hemp, burlap, bamboo, pine, hardwood, and softwood. Typically, the long natural fibers are better for increasing the stiffness of the composite layer (e.g. hemp, burlap, bamboo). The recycled natural fibers may include, for example, mill waste, recycled wood waste, recycled softwoods, recycled hardwood and pine recycled wood wastes.

The low density composite layer includes a mixture of the thermoplastic resin and the natural fiber. As described earlier the natural fiber includes virgin and/or recycled fibers. Additionally, according to one embodiment, the low density composite layer further comprises other recycled materials (e.g. recycled resin, or carpet waste). Preferably the low density composite layer includes between about 50% and about 70% of thermoplastic resin and between about 30% and about 50% of natural fiber. More preferably, in order to reduce cost and to improve the mechanical properties of the composite layer, the low density composite layer includes a 50:50 mix of thermoplastic resin and natural fiber. Preferably, the low density composite layer has a thickness of between about 0.075 inches and about 0.5 inches

In one embodiment the low density layer is formed by combining thermoplastic pellets with the natural fiber and at least one foaming agent and mixing (e.g. extruding) the composite layer. An example of the type of extruder that may be used to mix and extrude the composite layer is a melt screw extruder. The extruded product will be a flattened composite layer. As discussed earlier, in one aspect, the composite layer comprises at least some recycled materials selected from the group comprising recycled natural fibers and recycled synthetic materials.

The low density composite layer provides a solid board that may be used as a core layer in a structural laminate allowing for easy manufacturing while providing the structural properties required in a panel. The foamed solid board provides a light weight core that reduces the overall weight of the panel.

The low density composite layer also provides an improved impact resistance compared with some of the conventional panels. The use of a pre-formed solid board as the core reduces issues with defective cores since the core is pre-fabricated.

To form a low density composite laminate or panel initially the composite layer is manufactured, as described above. A panel is then formed by securing the composite layer between first and second metal skins. The following methods provide examples of different ways of forming the panel but are not meant to be limiting.

The composite panel may be formed using a batch press which places the composite layer between two metal skins including an adhesive layer between the composite layer and each metal skin. The batch press will apply both pressure and temperature to the panel to form the panel and adhere the composite layer to the skins. The amount of pressure that may be applied using this method is in the range of between about 50 psi and about 150 psi. The batch press may be used at a temperature in the range of about 250° F. to about 400° F. More preferably the batch press method is conducted at a temperature about 300° F. It will be understood that if a thermoplastic adhesive is used, the panel must be cooled to below about 200° F. to solidify the adhesive layer before removing pressure from the panel.

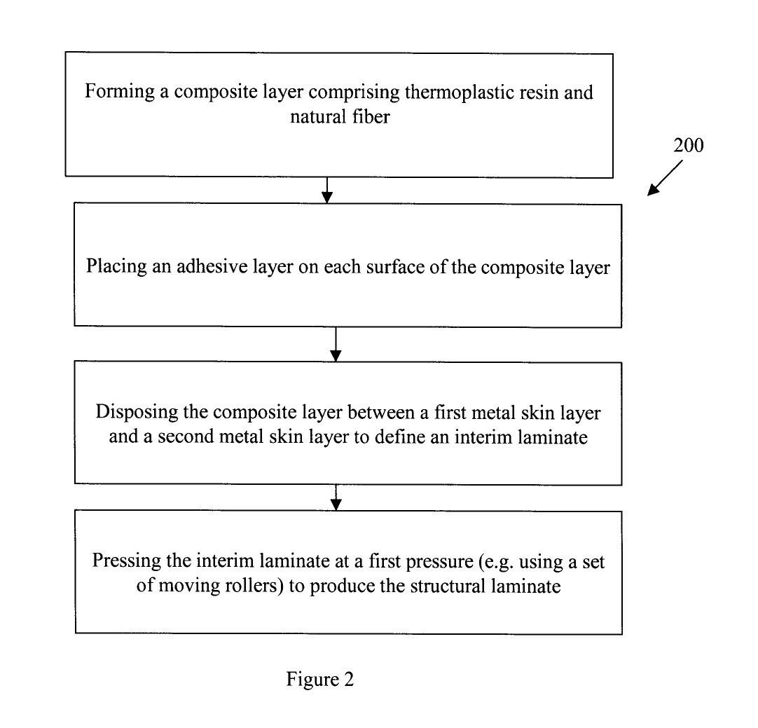

According to one embodiment illustrated in FIG. 2, the process 200 for forming the low density composite panel comprises: forming a low-density composite layer comprising thermoplastic resin and natural fiber; placing an adhesive layer on each surface of the composite layer; disposing the composite layer between a first metal skin layer and a second metal skin layer to define an interim laminate; and pressing the interim laminate at a first pressure to produce the structural laminate. In one aspect, the composite panel may be formed using a continuous laminator (e.g. a set of rollers or two moving belt presses or nip rollers) which receives therebetween the composite layer disposed between the two metal skins. There is also disposed an adhesive layer between the composite layer and each metal skin. The continuous laminator (e.g. using the set of rollers) will receive and apply pressure to the panel to form the panel and adhere the composite layer to the metal skins. The amount of pressure that may be applied is in the range of 50 psi to 150 psi. In this case, the continuous laminator may be two rollers which each receive one of the metal skins and the composite layer disposed therebetween. The metal skins may include an adhesive layer pre-applied or the adhesive layer may be added to each of the metal skins while the composite panel passes through the rollers. According to the present embodiment, the composite layer and the sheet metal can each be used at room temperature such that heating of the panel (or heating of the composite layer) is not needed to form the panel. In one aspect, in order to cause the adhesive layers to bind the composite layer to the skins, the adhesive layers may be heated at a predetermined range. However, it will be understood that other types of adhesives may be used that will bind the composite layer to the skin at for example, room temperature such that no heating of the adhesives is needed. As described earlier, according to one embodiment, a foaming agent is incorporated into the composite layer to reduce the density of the composite layer and result in a lighterweight composite layer. The composite layer disposed between the metal skins and having the foaming agent therein is then received by the continuous laminator as described above for producing the structural laminate.

The composite panel may also be formed using a roll coater which places a liquid adhesive between the composite layer and each of the metal skins and allows the liquid adhesive to cure and secure the composite layer in place. This process uses a batch press, continuous laminator, nip roller or multiple nip rollers to apply a low pressure to provide good contact between the composite layer and each of the metal skins in order to form the panel. For example, the applied pressure may be in the range of about 25 to about 50 psi.

In an alternative embodiment, the structural laminate is formed by extruding the composite layer between a first and second metal skin without the requirement of an adhesive layer.

In an alternative embodiment, the composite layer may be surface treated prior to being placed in the structural laminate. The surface treatment may include the use of flame, plasma or corona treating. The use of the surface treatment provides a more reactive surface on the composite layer allowing the adhesive to bond more readily to the composite layer.

Examples of the type of applications for the low density structural laminate of the present invention include, but are not limited to the following: side and/or door panels and/or wall panels in truck trailers and other automotives, interior liner panels in truck trailers, architectural and/or decorative panels and automotive applications.

The following panel was made according to the present invention. The structural panel included two 0.018 inch HSLA skins and a composite layer placed therebetween in accordance with the description provided above. The total thickness of the panel was 0.240 inches and the panel had a flexural stiffness of 1250 lbs/inch (based on a 1 inch×6 inch sample) with a nominal weight of 2.35 lbs/ft².

As will be understood by a person skilled in the art, composite materials referred to herein, refer to materials made from two or more constituent materials with different physical and/or chemical properties which remain separate and distinct on a macroscopic level within the finished structure. Generally, there are two different categories of constituent materials which include matrix and reinforcement. In composite materials, at least one portion of each type is needed. The matrix material (e.g. thermoplastic resin as described above) is adapted for surrounding and supporting the reinforcement materials (e.g. one or more of natural fibers and synthetic materials) by maintaining their relative positions. The reinforcement materials impart their special mechanical and physical properties to enhance the matrix properties. As discussed above, the natural and/or synthetic materials may be pre-impregnated by the resin.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments. Further, all of the claims are hereby incorporated by reference into the description of the preferred embodiments.

All publications, patents and patent applications referred to herein are incorporated by reference in their entirety to the same extent as if each individual publication, patent or patent application was specifically and individually indicated to be incorporated by reference in its entirety.

1. A structural laminate comprising:
a core layer disposed between and bonded to each of a first metal skin layer and a second metal skin layer, the first and second metal skin layers each having a thickness selected from about 0.0005 and about 0.030 inches, the core layer comprising a low density composite layer being selected from at least one of a low density natural-fiber plastic composite and a mixture of thermoplastic resin and natural fiber, wherein the low density composite layer is a flattened low density composite having a uniform thickness selected from about 0.075 and about 0.5 inches;
wherein the core further comprises; a first adhesive layer, having a thickness selected from about 0.0005 and about 0.010 inches, interposed between the first metal skin layer and the low density composite layer; and a second adhesive layer, having a thickness selected from about 0.0005 and 0.010 inches, interposed between the second metal skin layer and the low density composite layer;
wherein the first and second adhesive layers comprise a reactive hot melt polyurethane adhesive; and
wherein said structural laminate is in the form of a panel comprising a door or wall panel of an automotive truck or trailer.

2. (canceled)

3. (canceled)

4. The structural laminate as defined in claim 1, wherein the composite layer further comprises at least one foaming agent.

5. The structural laminate as defined in claim 1, wherein the low density composite layer comprises at least some recycled materials selected from the group comprising recycled natural fibers and recycled synthetic materials.

6. (canceled)

7. The structural laminate as defined in claim 1, wherein the thermoplastic resin is selected from the group comprising polypropylene, polyethylene and nylon.

8. The structural laminate as defined in claim 1, wherein the natural fiber is selected from the group comprising wood fiber, rice husks, plant fiber, mill waste, recycled wood waste, recycled softwoods, and recycled hardwood wastes.

9. (canceled)

10. The structural laminate as defined in claim 1, wherein the low density composite layer is a foamed low density natural-fiber plastic composite.

11. The structural laminate as defined in claim 1, wherein the low density composite layer comprises between about 50% and about 70% thermoplastic resin.

12. The structural laminate as defined in claim 1, wherein the low density composite layer comprises between about 30% and about 50% natural fiber.

13. The structural laminate as defined in claim 1, wherein the low density composite layer comprises a 50:50 mixture of thermoplastic resin and natural fiber.

14. The structural laminate as defined in claim 1, wherein the low density composite layer has a thickness of between about 0.075 inches and about 0.5 inches.

15. The structural laminate as defined in claim 1, wherein the first and second metal skin layers are the same or different and are formed of a material selected from the group comprising: aluminum, cold rolled steel, tin-coated steel, zinc-coated steel, low carbon micro-alloyed high-strength steel and stainless steel.

16. The structural laminate as defined in claim 15, wherein the first and second metal skin layers are pre-painted on at least one side.

17.-24. (canceled)

25. (canceled)
